(19) United States
(12) Patent Application Publication
(10) Pub. No.: US 2026/0029292 A1
(43) Pub. Date: Jan. 29, 2026

(54) LIQUID LEAKAGE DETECTION DEVICE AND INK JET RECORDING APPARATUS

(71) Applicant: SEIKO EPSON CORRPORATION, Tokyo (JP)

(72) Inventors: Kohei KUMAMOTO, Shiojiri-shi (JP); Jun SATO, Shiojiri-shi (JP); Kazushi ARUGA, Matsumoto-shi (JP); Masahiki YOSHIDA, Shiojiri-shi (JP); Taro TAKEKOSHI, Shiojiri-shi (JP)

(73) Assignee: SEIKO EPSON CORRPORATION, Tokyo (JP)

(21) Appl. No.: 19/278,489

(22) Filed: Jul. 23, 2025

(30) Foreign Application Priority Data
Jul. 24, 2024 (JP) 2024-118318

(51) Int. Cl. G01M 3/16; B41J 2/175; B41J 29/00

(52) U.S. Cl. CPC G01M 3/16; B41J 2/175; B41J 29/00

(57) ABSTRACT

A liquid leakage detection device provided inside an ink jet recording apparatus includes an ink detection unit configured with, as a pair of electrode terminals, an exposed conductor portion of a first core included in a multi-core flat cable and an exposed conductor portion of a second core included in the multi-core flat cable; and a detection circuit configured to detect that a liquid leaks by detecting that a potential difference between the pair of electrode terminals is less than a threshold defined in advance.

The present application is based on, and claims priority from JP Application Serial Number 2024-118318, filed Jul. 24, 2024, the disclosure of which is hereby incorporated by reference herein in its entirety.

### BACKGROUND

### 1. Technical Field

The present disclosure relates to a liquid leakage detection device and an ink jet recording apparatus.

### 2. Related Art

JP-A-2007-160825 describes a technique for an ink leakage detection mechanism in a printer. In the technique described in JP-A-2007-160825, a pair of electrode terminals function as an ink detection unit.

In order to improve the accuracy of ink leakage detection, ink detection units are provided at a plurality of locations where ink leakage is likely to occur inside the printer. In the related art, each ink detection unit is individually coupled to a control unit by wiring. As a result, there is an issue that a space occupied by the wiring that couples the ink detection units and the control unit in the limited space inside the printer is large. Therefore, it was desired to improve the space efficiency inside the printer.

### SUMMARY

The present disclosure can be implemented in the following aspects.

According to an aspect of the present disclosure, there is provided a liquid leakage detection device provided inside an ink jet recording apparatus. The liquid leakage detection device includes an ink detection unit configured with, as a pair of electrode terminals, an exposed conductor portion of a first core included in a multi-core flat cable and an exposed conductor portion of a second core included in the multi-core flat cable; and a detection circuit configured to detect that a liquid leaks by detecting that a potential difference between the pair of electrode terminals is less than a threshold defined in advance.

According to another aspect of the present disclosure, there is provided an ink jet recording apparatus. The ink jet recording apparatus includes a liquid flow unit, an ejection execution unit, a case accommodation unit, a control unit, and a liquid leakage detection device. The liquid leakage detection device includes an ink detection unit configured with, as a pair of electrode terminals, an exposed conductor portion of a first core included in a multi-core flat cable and an exposed conductor portion of a second core included in the multi-core flat cable; and a detection circuit configured to detect that a liquid leaks by detecting that a potential difference between the pair of electrode terminals is less than a threshold defined in advance.

### BRIEF DESCRIPTION OF THE DRAWINGS

FIG. 1 is a schematic perspective view illustrating an external configuration of a printing apparatus including a liquid leakage detection device according to the present embodiment.

FIG. 2 is a schematic view of the printing apparatus when viewed from a front surface side.

FIG. 3 is an explanatory diagram illustrating a circuit configuration of the liquid leakage detection device.

FIG. 4 is an explanatory diagram illustrating a configuration of an ink detection unit.

FIG. 5 is an explanatory diagram of a method of detecting occurrence of ink leakage.

FIG. 6 is an explanatory diagram of a method of disposing an ink detection unit according to another embodiment (B2).

FIG. 7 is an explanatory diagram illustrating an example in which a processed multi-core flat cable FC2 is disposed in another embodiment (B2).

FIG. 8 is an explanatory diagram illustrating a circuit configuration of a detection circuit in another embodiment (B5).

### DESCRIPTION OF EMBODIMENTS

### A. Embodiment

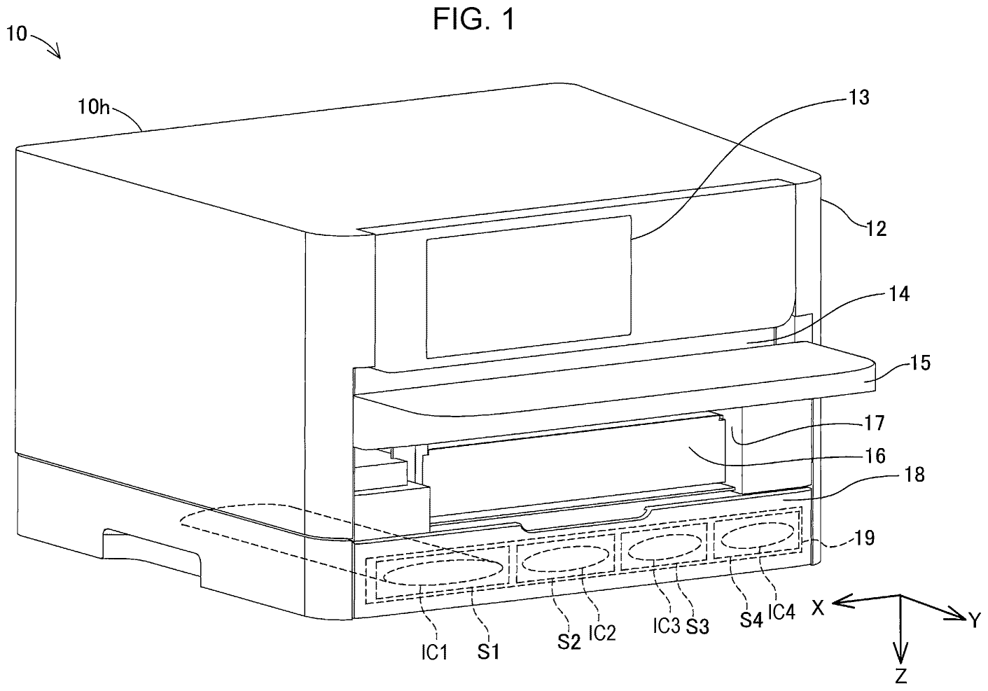

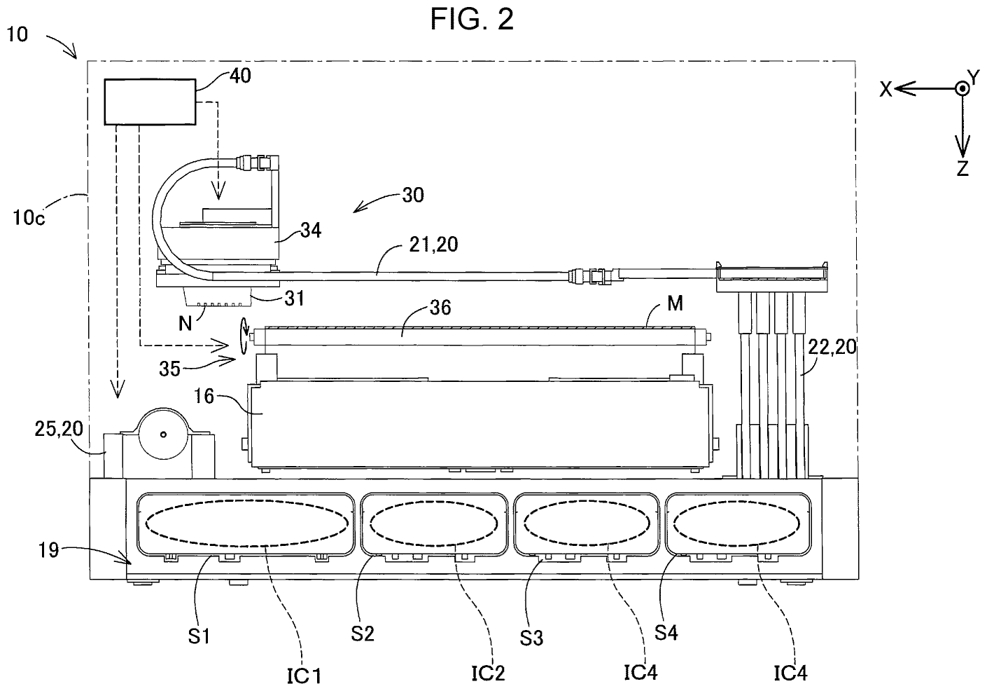

FIG. 1 is a schematic perspective view illustrating an external configuration of a printing apparatus 10 including a liquid leakage detection device 70 according to the present embodiment. In FIG. 1, an XYZ orthogonal coordinate system is defined. The Z axis is in a gravity direction. The +Z direction is the gravity direction. The Z-axis direction coincides with the up-down direction of the printing apparatus 10. The X axis and the Y axis are along the horizontal plane. The Y axis is in the front-rear direction of the printing apparatus 10. The +Y direction is a direction from the rear surface side toward the front surface side of the printing apparatus 10. The X axis is in the left-right direction of the printing apparatus 10. The +X direction coincides with a direction from the right side to the left side when the user faces the front surface of the printing apparatus 10. FIG. 2 is a schematic view of the printing apparatus 10 when a housing 10h and a cover member 18 are removed and the printing apparatus 10 is viewed from the front surface side.

The printing apparatus 10 includes the housing 10h. The printing apparatus 10 further includes a liquid flow unit 20, an ejection execution unit 30, a medium transport unit 35, a control unit 40, and the liquid leakage detection device 70 that are disposed in the housing 10h. In FIG. 1, the liquid flow unit 20, the ejection execution unit 30, the medium transport unit 35, the control unit 40, and the liquid leakage detection device 70 are not illustrated. In FIG. 2, the liquid leakage detection device 70 is not illustrated.

The printing apparatus 10 is an ink jet printer. The printing apparatus 10 is also referred to as an “ink jet recording apparatus”. The printing apparatus 10 forms an image by ejecting ink as an example of a liquid to record ink dots on printing paper, which is a medium. Target media to which the printing apparatus 10 ejects ink are not limited to printing paper, and may be plastic, film, fiber, cloth, leather, metal, glass, wood, ceramics, or other materials.

As illustrated in FIG. 1, the housing 10h is a substantially rectangular parallelepiped hollow casing that constitutes an exterior of the printing apparatus 10. A front surface portion 12 of the housing 10h is provided with an operation panel 13, a medium discharge port 14, a paper discharge tray 15, a paper feed tray 16, a mounting port 17, the cover member 18, and a case accommodation unit 19.

The operation panel 13 functions as a display unit that displays information and an input unit that accepts a user's operation. The operation panel 13 is, for example, a touch panel. The medium discharge port 14 is an outlet of the medium discharged from the inside of the printing apparatus 10. The medium discharge port 14 is formed as a slit-shaped opening portion having a large width in the X-axis direction. The paper discharge tray 15 is disposed on the lower side of the medium discharge port 14. The paper discharge tray 15 receives the medium discharged from the medium discharge port 14.

The paper feed tray 16 accommodates the medium. The mounting port 17 is an opening for inserting the paper feed tray 16 into the housing 10h. The mounting port 17 is formed as a substantially rectangular opening portion having a large width in the X-axis direction on the lower side of the paper discharge tray 15. When replenishing the medium, the user stores the medium in the paper feed tray 16 pulled out from the mounting port 17 in the +Y direction. Thereafter, the user loads the paper feed tray 16 into the printing apparatus 10 from the mounting port 17.

The cover member 18 is a plate-shaped member made of resin and constitutes a part of the exterior of the printing apparatus 10. The cover member 18 has a substantially rectangular shape having a large width in the X-axis direction. The cover member 18 is disposed below the paper feed tray 16. The cover member 18 has a claw section (not illustrated) at an outer peripheral edge thereof, and is detachably attached to the housing 10h. The cover member 18 covers cases S1 to S4 stored in the case accommodation unit 19.

The case accommodation unit 19 is a space formed inside the housing 10h for storing the cases S1 to S4. The cases S1 to S4 are configured as tray-like containers. The cases S1 to S4 are used for mounting ink cartridges IC1 to IC4 on the printing apparatus 10. The cases S1 to S4 are arranged in the X-axis direction in the case accommodation unit 19. The cases S1 to S4 are mounted on the printing apparatus 10 in a state where the ink cartridges IC1 to IC4 are accommodated. The ink cartridges IC1 to IC4 are so-called ink packs. The ink cartridges IC1 to IC4 store black, cyan, magenta, and yellow inks, respectively. When setting the ink cartridge, the user stores the ink cartridge in the case pulled out in the +Y direction. Thereafter, the user inserts the case into the case accommodation unit 19.

As illustrated in FIG. 2, the liquid flow unit 20 includes a plurality of tubes 21, a plurality of flow pipes 22, and a pump 25. The plurality of tubes 21 are arranged in the Y-axis direction. The plurality of tubes 21 are coupled to a print head 31. The plurality of tubes 21 are coupled to the plurality of flow pipes 22. When the pump 25 operates, the ink inside the ink cartridges IC1 to IC4 is pushed out to the flow pipes 22. The ink in the ink cartridges IC1 to IC4 is supplied to the print head 31 via the flow pipes 22 and the tubes 21.

The ejection execution unit 30 includes the print head 31 and a carriage 34. The print head 31 receives the supply of ink via the plurality of tubes 21 of the liquid flow unit 20. The print head 31 includes a nozzle N that ejects the ink supplied from the liquid flow unit 20 downward. The print head 31 moves together with the carriage 34 and ejects the ink supplied from the ink cartridges IC1 to IC4 onto the medium. The carriage 34 is provided with the print head 31 and is caused to reciprocate in the X-axis direction, which is the main scanning direction, by a driving mechanism (not illustrated).

The medium transport unit 35 transports a medium M in the sub-scanning direction under the control of the control unit 40. The sub-scanning direction is the Y-axis direction. The medium transport unit 35 includes a transport roller 36 disposed in the X-axis direction below the print head 31. The paper feed tray 16 is disposed below the transport roller 36.

When the print processing is executed, the control unit 40 causes the medium transport unit 35 to transport the medium M in the sub-scanning direction. Further, the control unit 40 causes the print head 31 to reciprocate in the main scanning direction along the transport roller 36 by the carriage 34 above the transport roller 36. The control unit 40 causes the ink droplets to be ejected from the print head 31 to the printing surface of the medium M at a timing determined based on the print data. Accordingly, the ink dots are recorded on the medium M transported by the medium transport unit 35 at a position determined based on the print data, and an image based on the print data is formed.

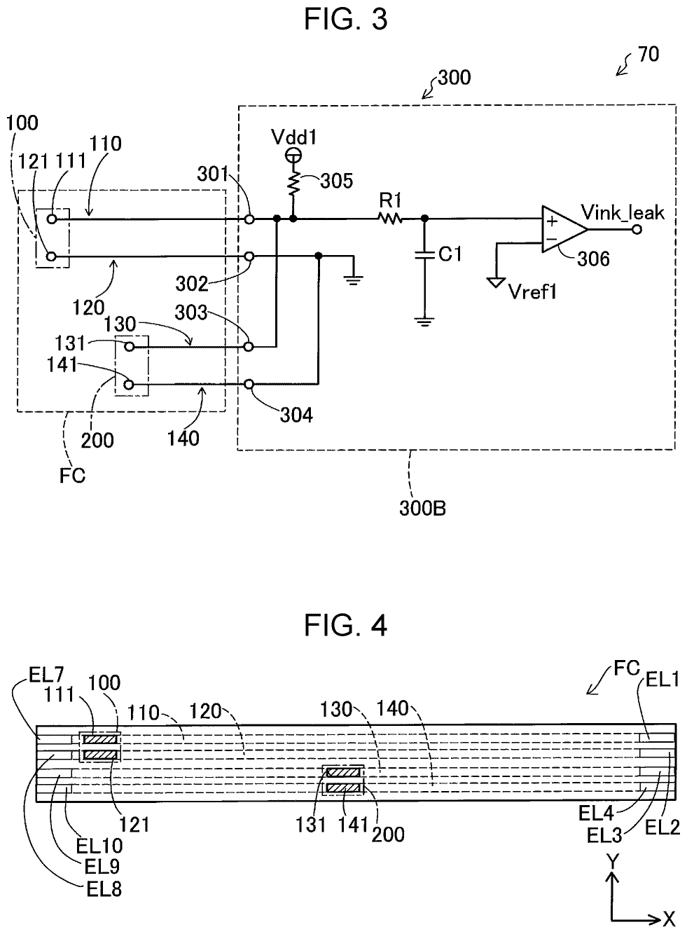

FIG. 3 is an explanatory diagram illustrating a circuit configuration of the liquid leakage detection device 70 provided inside the printing apparatus 10. FIG. 4 is an explanatory diagram illustrating a configuration of an ink detection unit. The liquid leakage detection device 70 detects the leakage of ink inside the printing apparatus 10. As illustrated in FIG. 3, the liquid leakage detection device 70 includes a first ink detection unit 100, a second ink detection unit 200, and a detection circuit 300.

The first ink detection unit 100 and the second ink detection unit 200 detect the leakage of the ink inside the printing apparatus 10. As illustrated in FIG. 4, the first ink detection unit 100 and the second ink detection unit 200 are configured with a multi-core flat cable FC. A flexible flat cable (hereinafter also referred to as FFC) is used as the multi-core flat cable FC. The FFC is formed by sandwiching a plurality of electric wires, which are arranged in parallel and which are conductors, with a flexible insulating film from above and below and crimping the electric wires. The multi-core flat cable FC has a first core 110, a second core 120, a third core 130, and a fourth core 140.

The first ink detection unit 100 is configured to include an electrode terminal 111, which is an exposed conductor portion of the first core 110, and an electrode terminal 121, which is an exposed conductor portion of the second core 120. The electrode terminals 111 and 121 are provided in the vicinity of one end portion of the multi-core flat cable FC. The first core 110 and the second core 120 are adjacent to each other. There is no other core between the first core 110 and the second core 120. The electrode terminals 111 and 121 are also referred to as a “pair of electrode terminals”. The electrode terminal 111 is formed by exposing a part of the first core 110. By removing a part of the insulating film covering the first core 110, a part of the first core 110 is exposed. The other electrode terminals are the same. The electrode terminal 121 is formed by exposing a part of the second core 120. The first ink detection unit 100 is also referred to as an “ink detection unit”. The electrode terminal 111 is also referred to as a “first electrode terminal”. The electrode terminal 121 is also referred to as a “second electrode terminal”.

The second ink detection unit 200 is configured to include an electrode terminal 131 which is an exposed conductor portion of the third core 130 and an electrode terminal 141 which is an exposed conductor portion of the fourth core 140. The third core 130 and the fourth core 140 are adjacent to each other. There is no other core between the third core 130 and the fourth core 140. The second core 120 is adjacent to the third core 130 on the side opposite to the side adjacent to the first core 110. There is no other core between the second core 120 and the third core 130. The electrode terminals 131 and 141 are also referred to as “the other pair of electrode terminals”. The electrode terminal 131 is formed by exposing a part of the third core 130. The electrode terminal 141 is formed by exposing a part of the fourth core 140. The electrode terminals 131 and 141 are provided in the intermediate region of the multi-core flat cable FC. The intermediate region of the multi-core flat cable FC includes a part including the intermediate point in the longitudinal direction of the multi-core flat cable FC, and does not include both end portions of the multi-core flat cable FC. On the other hand, the electrode terminals 111 and 121 are provided at the end portion of the multi-core flat cable FC on the −X side. The end portion of the multi-core flat cable FC includes a part including the end edge of the multi-core flat cable FC in the longitudinal direction. Further, the electrode terminals 111, 121, 131, and 141 are provided on the same surface of the multi-core flat cable FC. The electrode terminal 131 is also referred to as a “third electrode terminal”. The electrode terminal 141 is also referred to as a “fourth electrode terminal”.

The multi-core flat cable FC is disposed, for example, in the case accommodation unit 19 illustrated in FIG. 2, on the lower side of a portion where the case S1 and the liquid flow unit 20 are coupled to each other so that the longitudinal direction of the multi-core flat cable FC is in the X-axis direction. At this time, the multi-core flat cable FC is disposed such that the electrode terminals 111 and 121 and the electrode terminals 131 and 141 face the bottom surface of the case accommodation unit 19. As described above, the electrode terminals 111 and 121 are provided in the vicinity of one end portion of the multi-core flat cable FC, and the electrode terminals 131 and 141 are provided in the intermediate region of the multi-core flat cable FC. Therefore, the second ink detection unit 200 including the electrode terminals 131 and 141 is disposed at a position separated from the first ink detection unit 100 including the electrode terminals 111 and 121 in the direction in which the core extends. The position in the vicinity of one end portion of the multi-core flat cable FC means that the position is located at a position closer to electrodes EL7 to EL10 at the −X side end portion in a region between the electrodes EL7 to EL10 at the −X side end portion of the multi-core flat cable FC and the electrode terminals 131 and 141 in the example illustrated in FIG. 4.

As illustrated in FIG. 3, the detection circuit 300 detects that the ink has leaked inside the printing apparatus 10 by detecting a short circuit between the terminals of the electrode terminals 111 and 121 or a short circuit between the terminals of the electrode terminals 131 and 141. Since the ink is a conductor, when the ink leaks in the vicinity of the terminals of the electrode terminals 111 and 121, the terminals of the electrode terminals 111 and 121 are short-circuited by the ink. The same applies to the short circuit between the terminals of the electrode terminals 131 and 141. The detection circuit 300 is provided on a control substrate 300B. The control substrate 300B is disposed, for example, inside the control unit 40.

As illustrated in FIG. 4, electrodes EL1 to EL4 of the +X side end portion of the multi-core flat cable FC are electrically coupled to the control substrate 300B by a connector (not illustrated) corresponding to the four-core FFC. The connector is provided on the control substrate 300B.

As illustrated in FIG. 3, the detection circuit 300 includes a first leakage signal terminal 301, a first ground terminal 302, a second leakage signal terminal 303, a second ground terminal 304, a pull-up resistor 305, a comparator 306, a resistor R1, a capacitor C1, and a power supply Vdd1. In the present embodiment, the four electrodes of the −X side end portion of the multi-core flat cable FC are not used.

The first leakage signal terminal 301 and the second leakage signal terminal 303 are coupled to one end of the pull-up resistor 305. The first leakage signal terminal 301 is coupled to the electrode EL1 of the first core 110 via a connector. The second leakage signal terminal 303 is coupled to the electrode EL3 of the third core 130 via a connector. The power supply Vdd1 is coupled to the other end of the pull-up resistor 305. The potential of the power supply Vdd1 is set as a signal potential on the high-potential side. A constant voltage is applied from the power supply Vdd1 to the first leakage signal terminal 301 and the second leakage signal terminal 303 via the pull-up resistor 305. As a result, the potentials of the first leakage signal terminal 301 and the second leakage signal terminal 303 are fixed. The first leakage signal terminal 301 and the second leakage signal terminal 303 are coupled to an input terminal on the positive side of the comparator 306 via an RC circuit including the resistor R1 and the capacitor C1. The resistor R1 and the capacitor C1 are provided to output, to the comparator 306, the time integration of the input to the first leakage signal terminal 301.

The first ground terminal 302 is coupled to the electrode EL2 of the second core 120 via a connector. The second ground terminal 304 is coupled to the electrode EL4 of the fourth core 140 via a connector. The first ground terminal 302 and the second ground terminal 304 are grounded.

Signals are input to the input terminal on the positive side of the comparator 306 from the first leakage signal terminal 301 and the second leakage signal terminal 303. An input terminal on the negative side of the comparator 306 is signal-grounded. The potential of the point that is signal-grounded is set as a reference potential Vref1. The reference potential Vref1 is a potential on the low-potential side. When the potential of the signal input to the input terminal on the positive side is lower than the reference potential Vref1, the comparator 306 outputs a low signal as an output Vink_leak. When the potential of the signal input to the input terminal on the positive side is higher than the reference potential Vref1, the comparator 306 outputs a high signal as the output Vink_leak. The output Vink_leak of the comparator 306 is input to a processor (not illustrated) including an interface capable of receiving a digital signal. The processor (not illustrated) that receives the low signal as the output Vink_leak can detect that the ink leakage has occurred in the first ink detection unit 100 or the second ink detection unit 200. Further, for example, a processor (not illustrated) can notify the user that the ink leakage is detected.

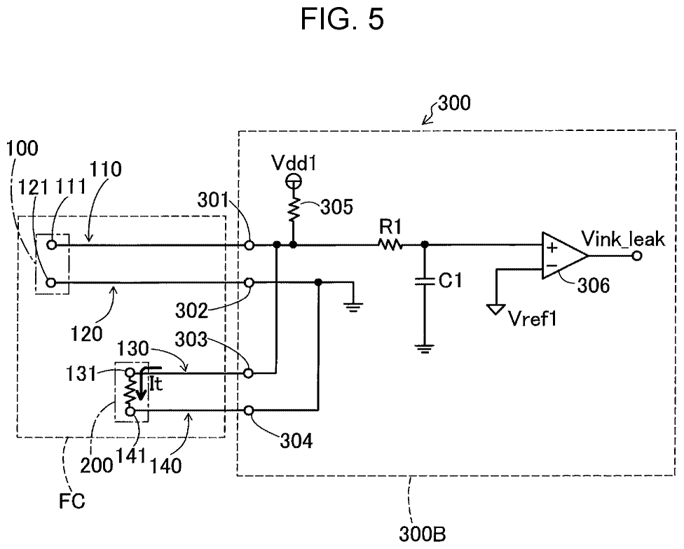

FIG. 5 is an explanatory diagram illustrating a method of detecting the leakage of ink. Here, it is assumed that the ink leakage occurs in the vicinity of the electrode terminals 131 and 141 constituting the second ink detection unit 200. The ink leakage means that the ink has leaked from the inside of the ink cartridges IC1 to IC4, the liquid flow unit 20, and other components.

When the leaked ink causes a short circuit between the terminals of the electrode terminals 131 and 141, a short-circuit current It flows between the electrode terminals 131 and 141. As a result, a voltage drop occurs in the third core 130, and the potential of the input signal to the input terminal on the positive side of the comparator 306 decreases. When the potential of the input signal to the input terminal on the positive side of the comparator 306 is lower than the reference potential Vref1 due to the voltage drop, the comparator 306 outputs a low signal as the output Vink_leak. The potential of the input signal to the input terminal on the positive side of the comparator 306 is lower than the reference potential Vref1, which indicates that at least one of the potential difference between the terminals of the electrode terminals 131 and 141 and the potential difference between the terminals of the electrode terminals 111 and 121 is less than a threshold defined in advance. In this case, the comparator 306 outputs the low signal as the output Vink_leak. As described above, it is possible to detect the ink leakage inside the printing apparatus 10 with a simple configuration.

In FIG. 5, an example in which the ink leakage occurs in the vicinity of the electrode terminals 131 and 141 is illustrated, and similarly, when the ink leaks between the terminals of the electrode terminals 111 and 121 and the terminals are short-circuited, the voltage drop occurs in the first core 110, and the comparator 306 outputs a low signal as the output Vink_leak.

In the present embodiment, the exposed conductor portion of the core included in the multi-core flat cable FC is used as the ink detection unit. In the configuration according to the present embodiment, the space occupied by the ink detection unit in the printer can be reduced as compared with a case where each ink detection unit is individually coupled to the control unit by wiring. Therefore, the space efficiency inside the printer can be improved. In addition, a plurality of ink detection units can be easily configured with a multi-core flat cable FC. Since the configuration of the liquid leakage detection device 70 is simple, the liquid leakage detection device 70 can be easily introduced into various types of printing apparatuses.

In the embodiment, the electrode terminals 111 and 121 are provided in the vicinity of one end portion of the multi-core flat cable FC. On the other hand, the electrode terminals 131 and 141 are provided in the intermediate region of the multi-core flat cable FC. As described above, the ink detection unit can be disposed at a desired position not only in the vicinity of the end portion of the multi-core flat cable FC.

Further, in the present embodiment, since it is not necessary to mount a component on the ink detection unit, the FFC is used as a multi-core flat cable FC for constituting the ink detection unit. As a result, it is possible to reduce the cost.

### B. Other Embodiments

(B1) In the above-described embodiment, an example in which the liquid leakage detection device 70 has two ink detection units has been described. For example, by using an FFC having six cores, the liquid leakage detection device 70 can be provided with three ink detection units. Further, by having the FFC having eight cores, the liquid leakage detection device 70 can be provided with four ink detection units. For example, four ink detection units can be disposed in the vicinity of the coupling portions between the ink cartridges IC1 to IC4 and the liquid flow unit 20. As described above, the number of the ink detection units can be increased or decreased according to the number of places where the liquid leakage is to be detected. Therefore, the degree of freedom in disposing the liquid leakage detection device 70 in the printing apparatus 10 is high.

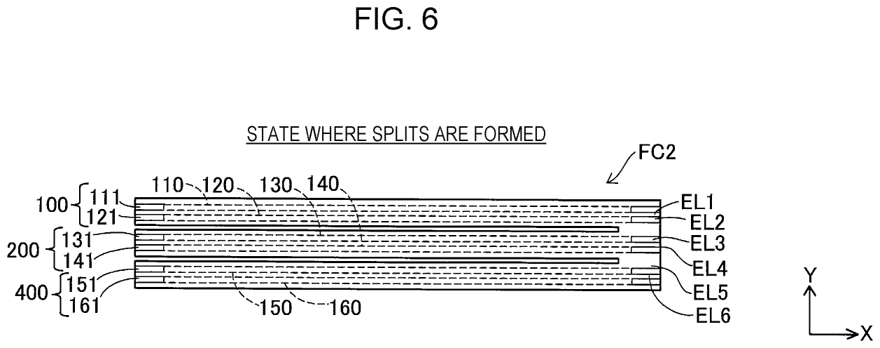

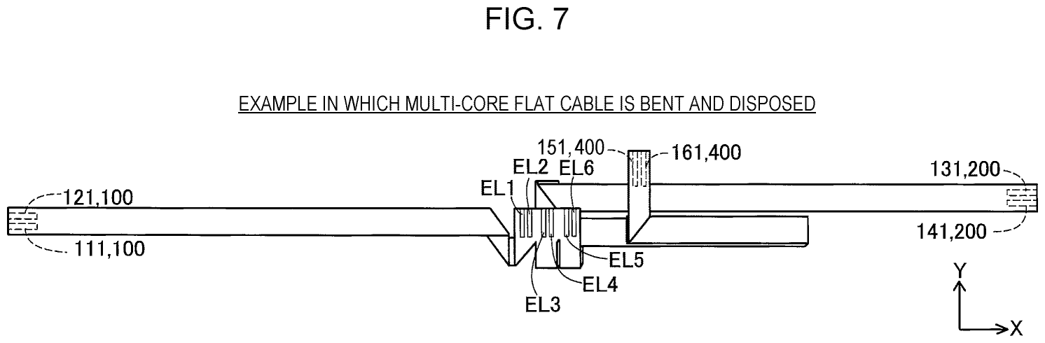

(B2) FIGS. 6 and 7 are explanatory diagrams illustrating a disposition method of the ink detection unit according to another embodiment (B2). FIG. 6 illustrates an aspect of processing of a multi-core flat cable FC2 having six cores. FIG. 7 illustrates an example in which the processed multi-core flat cable FC2 is disposed. The electrodes at both ends of the multi-core flat cable FC2 are formed on the same surface. In the multi-core flat cable FC2, the first core 110, the second core 120, the third core 130, the fourth core 140, a fifth core 150, and a sixth core 160 are arranged in this order. The liquid leakage detection device 70 according to another embodiment (B2) includes the first ink detection unit 100, the second ink detection unit 200, the detection circuit 300, and a third ink detection unit 400. The first ink detection unit 100, the second ink detection unit 200, and the third ink detection unit 400 are disposed, for example, on the lower side of a portion of the case accommodation unit 19 illustrated in FIG. 2 where the case S1 and the liquid flow unit 20 are coupled to each other. FIG. 7 illustrates an example in which the multi-core flat cable FC2 is divided into pairs of adjacent cores, and further bent and disposed so that the first ink detection unit 100, the second ink detection unit 200, and the third ink detection unit 400 are disposed at desired positions. The first ink detection unit 100 is configured to include the electrode terminal 111 and the electrode terminal 121 of the second core 120. As the electrode terminal 111, the electrode on the −X side of the first core 110 in FIG. 6 is used. As the electrode terminal 121, the electrode on the −X side of the second core 120 in FIG. 6 is used. Unlike the above embodiment, since the existing electrode is used, the work of removing the insulating film can be omitted. The second ink detection unit 200 is configured to include the electrode terminal 131 and the electrode terminal 141. As the electrode terminal 131, the electrode on the −X side of the third core 130 in FIG. 6 is used. As the electrode terminal 141, the electrode on the −X side of the fourth core 140 in FIG. 6 is used.

The third ink detection unit 400 is configured to include an electrode terminal 151 and an electrode terminal 161. As the electrode terminal 151, the electrode on the −X side of the fifth core 150 in FIG. 6 is used. As the electrode terminal 161, the electrode on the −X side of the sixth core 160 in FIG. 6 is used. In addition, electrodes EL1 to EL6 on the +X side of the multi-core flat cable FC2 are electrically coupled to the control substrate 300B by a connector which is not illustrated corresponding to the six-core FFC. The connector is provided on the control substrate 300B.

In another embodiment (B2), splits are formed in the multi-core flat cable FC2 along the spacing between cores from the end of the multi-core flat cable FC2 on the −X side illustrated in FIG. 6. Specifically, a split is formed along the spacing between the second core 120 and the third core 130. In addition, a split is formed along the spacing between the fourth core 140 and the fifth core 150. In the example illustrated in FIG. 7, splits are formed in the multi-core flat cable FC2 to extend to the vicinity of the electrodes EL1 to EL6 on the +X side of the multi-core flat cable FC2. However, the splits are formed in the multi-core flat cable FC2 so that the cores are not completely separated from each other.

As illustrated in FIG. 7, the first core 110 and the second core 120 are disposed in a state of being bent, and the third core 130 and the fourth core 140 are disposed in a state of being bent. Therefore, the first core 110 and the second core 120 extend in the −X direction, and the third core 130 and the fourth core 140 extend in the +X direction. That is, the first core 110 and the second core 120 extend in a direction different from the direction in which the third core 130 and the fourth core 140 extend.

In addition, the fifth core 150 and the sixth core 160 are disposed in a state of being bent such that the electrode terminals 151 and 161 constituting the third ink detection unit 400 are disposed between the first ink detection unit 100 including the first core 110 and the second core 120 and the second ink detection unit 200 including the third core 130 and the fourth core 140 in the X-axis direction in FIG. 7. Therefore, the first ink detection unit 100, the second ink detection unit 200, and the third ink detection unit 400 can be disposed at intervals in the X-axis direction. As described above, the first ink detection unit 100 configured with the electrode terminals 111 and 121, the second ink detection unit 200 configured with the electrode terminals 131 and 141, and the third ink detection unit 400 configured with the electrode terminals 151 and 161 are disposed at a distance from each other inside the printing apparatus 10.

(B3) The electrodes EL1 to EL4 of the multi-core flat cable FC do not necessarily have to be electrically coupled directly to the control substrate 300B. The fact that the electrodes EL1 to EL4 of the multi-core flat cable FC are electrically coupled directly to the control substrate 300B means that the electrodes EL1 to EL4 of the multi-core flat cable FC are coupled to the control substrate 300B by using a cable, a harness, or the like without using other components. The electrodes EL1 to EL4 may be coupled to the control substrate 300B by using a cable, a harness, or the like.

(B4) In the above embodiment, an example in which the comparator 306 is used to detect the occurrence of a short circuit between the pair of electrode terminals has been described. Alternatively, an analog-to-digital converter may be used instead of the comparator 306.

(B5) In the above embodiment, an example in which one comparator 306 included in the detection circuit 300 detects a short circuit in the first ink detection unit 100 or the second ink detection unit 200 has been described. Alternatively, the detection circuit 300 may include one comparator for each ink detection unit.

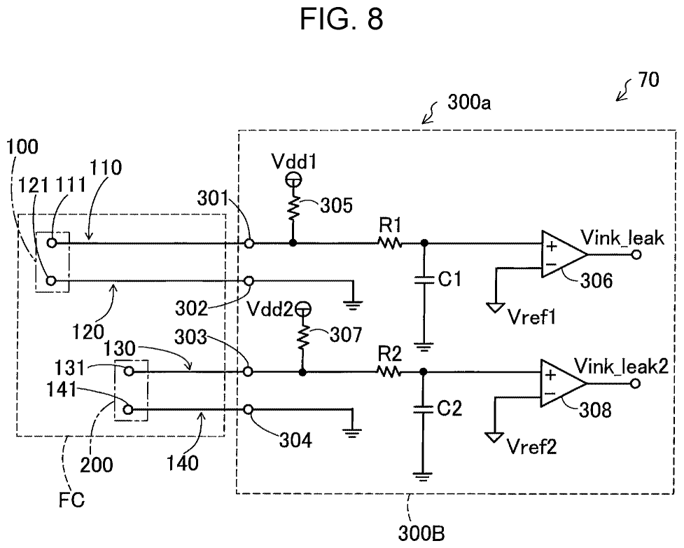

FIG. 8 is an explanatory diagram illustrating a circuit configuration of a detection circuit 300a in another embodiment (B5). As illustrated in FIG. 8, the detection circuit 300a includes the first leakage signal terminal 301, the first ground terminal 302, the second leakage signal terminal 303, the second ground terminal 304, the pull-up resistor 305, the comparator 306, a pull-up resistor 307, a comparator 308, the resistor R1, a resistor R2, the capacitor C1, a capacitor C2, the power supply Vdd1, and a power supply Vdd2.

The first leakage signal terminal 301 is coupled to one end of the pull-up resistor 305. The first leakage signal terminal 301 is coupled to the electrode EL1 of the first core 110 via a connector. The power supply Vdd1 is coupled to the other end of the pull-up resistor 305. The potential of the power supply Vdd1 is set as a signal potential on the high-potential side. A constant voltage is applied from the power supply Vdd1 to the first leakage signal terminal 301 via the pull-up resistor 305. As a result, the potential of the first leakage signal terminal 301 is fixed. The first leakage signal terminal 301 is coupled to the input terminal on the positive side of the comparator 306 via an RC circuit including the resistor R1 and the capacitor C1. The first ground terminal 302 is coupled to the electrode EL2 of the second core 120 via a connector. The first ground terminal 302 is grounded.

A signal is input from the first leakage signal terminal 301 to the input terminal on the positive side of the comparator 306. The input terminal on the negative side of the comparator 306 is signal-grounded. The potential of the point that is signal-grounded is set as the reference potential Vref1. The reference potential Vref1 is a potential on the low-potential side. When the potential of the signal input to the input terminal on the positive side is lower than the reference potential Vref1, the comparator 306 outputs a low signal as the output Vink_leak. When the potential of the signal input to the input terminal on the positive side is higher than the reference potential Vref1, the comparator 306 outputs a high signal as the output Vink_leak. The output Vink_leak of the comparator 306 is input to a processor which is not illustrated including an interface capable of receiving a digital signal. The processor (not illustrated) that receives the low signal as the output Vink_leak can detect that the ink leakage has occurred in the first ink detection unit 100.

The second leakage signal terminal 303 is coupled to one end of the pull-up resistor 307. The second leakage signal terminal 303 is coupled to the electrode EL3 of the third core 130 via a connector. The power supply Vdd2 is coupled to the other end of the pull-up resistor 307. The potential of the power supply Vdd2 is set as the signal potential on the high-potential side. A constant voltage is applied from the power supply Vdd2 to the second leakage signal terminal 303 via the pull-up resistor 307. As a result, the potential of the second leakage signal terminal 303 is fixed. The second leakage signal terminal 303 is coupled to an input terminal on the positive side of the comparator 308 via an RC circuit including the resistor R2 and the capacitor C2. The second ground terminal 304 is coupled to the electrode EL4 of the fourth core 140 via a connector. The second ground terminal 304 is grounded.

A signal is input from the second leakage signal terminal 303 to the input terminal on the positive side of the comparator 308. An input terminal on the negative side of the comparator 308 is signal-grounded. The potential of the portion signal-grounded is set as a reference potential Vref2. The reference potential Vref2 is a potential on the low-potential side. The reference potential Vref1 and the reference potential Vref2 may be the same potential or different potentials. When the potential of the signal input to the input terminal on the positive side is lower than the reference potential Vref2, the comparator 308 outputs a low signal as an output Vink_leak2. When the potential of the signal input to the input terminal on the positive side is higher than the reference potential Vref2, the comparator 308 outputs a high signal as the output Vink_leak2. The output Vink_leak2 of the comparator 308 is input to a processor which is not illustrated including an interface capable of receiving a digital signal. The processor which is not illustrated that receives the low signal as the output Vink_leak2 can detect that the ink leakage has occurred in the second ink detection unit 200. In the above embodiment, it is not possible to determine in which of the first ink detection unit 100 and the second ink detection unit 200 the ink has leaked. However, in another embodiment (B5), it is possible to determine in which of the first ink detection unit 100 and the second ink detection unit 200 the ink has leaked.

In addition, the comparators 306 and 308 in FIG. 8 may be replaced with analog-to-digital converters.

(B6) For example, when the first ink detection unit 100 is disposed in the case accommodation unit 19 such that the electrode terminals 111 and 121 face the bottom surface of the case accommodation unit 19, the liquid absorbing material may be disposed at a position on the bottom surface of the case accommodation unit 19 where the electrode terminals 111 and 121 are disposed. The liquid absorbing material is formed by shaping a porous material into a plate shape. The liquid absorbing material may be disposed at the position where the second ink detection unit 200 is disposed in the same manner.

(B7) In another embodiment (B2), an example in which the first ink detection unit 100, the second ink detection unit 200, and the third ink detection unit 400 are disposed on the lower side of the portion where the case S1 and the liquid flow unit 20 are coupled to each other, has been described. However, the first ink detection unit 100, the second ink detection unit 200, and the third ink detection unit 400 may not be disposed along the same plane. For example, the first ink detection unit 100, the second ink detection unit 200, and the third ink detection unit 400 may be disposed around the print head 31, below the carriage 34, below the pump 25, or the like.

(B8) In the above-described embodiment, an example has been described in which the electrode terminals 111, 121, 131, and 141 are provided on the same surface of the multi-core flat cable FC. However, the electrode terminals 111 and 121 constituting the first ink detection unit 100 and the electrode terminals 131 and 141 constituting the second ink detection unit 200 may be provided on different surfaces of the multi-core flat cable FC.

(B9) In another embodiment (B2), an example in which all of the core pairs separated from each other are bent has been described, but only some of the core pairs may be bent and disposed.

(B10) In another embodiment (B2), although an example of constituting one ink detection unit by pairing adjacent cores has been described, the cores constituting one ink detection unit may not be adjacent to each other. For example, in a multi-core flat cable FC having four cores, it is assumed that the first core 110, the second core 120, the third core 130, and the fourth core 140 are arranged in this order. In this case, the first core 110 and the third core 130 form the first ink detection unit 100. The second core 120 and the fourth core 140 form the second ink detection unit 200. In addition, a split is formed along the spacing between the cores. The cores can be bent and disposed such that the direction in which the first core 110 and the third core 130 extend and the direction in which the second core 120 and the fourth core 140 extend are in the opposite direction.

(B11) In the above-described embodiment, an example is described in which, as illustrated in FIG. 4, the electrode terminals 111 and 121 are provided in the vicinity of one end portion of the multi-core flat cable FC, and the electrode terminals 131 and 141 are provided in the intermediate region of the multi-core flat cable FC. However, the electrode terminals 111 and 121 and the electrode terminals 131 and 141 may be provided in the vicinity of the end portion of the same side of the multi-core flat cable FC. Further, the electrode terminals 111 and 121 may be provided in the vicinity of one end portion of the multi-core flat cable FC, and the electrode terminals 131 and 141 may be provided in the vicinity of the other end portion of the multi-core flat cable FC. Further, the electrode terminals 111 and 121 and the electrode terminals 131 and 141 may be provided in the intermediate region of the multi-core flat cable FC.

(B12) In the above-described embodiment, an example in which two ink detection units are provided has been described, but the liquid leakage detection device 70 may include only one ink detection unit.

The present disclosure is not limited to the above-described embodiments, and can be realized in various configurations without departing from the spirit thereof. For example, technical features in the embodiments corresponding to technical features in each aspect described in “SUMMARY” section can be appropriately replaced or combined to partially or entirely solve the above-described problems, or to partially or entirely obtain the above-described advantageous effects. Further, when the technical features are not described as essential in the present specification, the technical features can be appropriately deleted.

### C. Other Aspects

(1) According to an aspect of the present disclosure, there is provided a liquid leakage detection device provided inside an ink jet recording apparatus. The liquid leakage detection device includes an ink detection unit configured with, as a pair of electrode terminals, an exposed conductor portion of a first core included in a multi-core flat cable and an exposed conductor portion of a second core included in the multi-core flat cable; and a detection circuit configured to detect that a liquid leaks by detecting that a potential difference between the pair of electrode terminals is less than a threshold defined in advance.

According to the above aspect, by using, as the ink detection unit, the exposed portion of the core included in the multi-core flat cable, the space occupied by the ink detection unit in the ink jet recording apparatus can be reduced, and the space efficiency inside the ink jet recording apparatus can be improved.

(2) The liquid leakage detection device according to the above aspect further includes a second ink detection unit configured with, as another pair of electrode terminals, an exposed conductor portion of a third core included in the multi-core flat cable and an exposed conductor portion of a fourth core included in the multi-core flat cable. The detection circuit detects that a liquid leaks by detecting that a potential difference between the pair of electrode terminals or between the other pair of electrode terminals is less than the threshold defined in advance. The second ink detection unit may be disposed at a position different from a position where the ink detection unit is disposed.

According to the above aspect, a plurality of ink detection units can be configured with a multi-core flat cable.

(3) In the liquid leakage detection device according to the above aspect, the first core and the second core are disposed adjacent to each other in the multi-core flat cable, and the third core and the fourth core are disposed adjacent to each other in the multi-core flat cable. The second core is adjacent to the third core on a side opposite to the first core. The pair of electrode terminals are configured with a conductor portion of the first core exposed on one surface of the multi-core flat cable and a conductor portion of the second core exposed on the surface. The other pair of electrode terminals are configured with a conductor portion of the third core exposed on the surface and a conductor portion of the fourth core exposed on the surface. The first core and the second core extend in a direction different from a direction in which the third core and the fourth core extend by at least the first core and the second core being disposed while being bent in a state where a split is formed from an end of the multi-core flat cable along a spacing between the second core and the third core. The pair of electrode terminals and the other pair of electrode terminals are disposed along the same plane inside the ink jet recording apparatus.

(4) In the liquid leakage detection device according to the aspect, the first core and the second core are disposed adjacent to each other in the multi-core flat cable, and the third core and the fourth core are disposed adjacent to each other in the multi-core flat cable. The second core is adjacent to the third core on a side opposite to the first core. The pair of electrode terminals may be provided in the vicinity of one end portion of the multi-core flat cable, and the other pair of electrode terminals may be provided in an intermediate region of the multi-core flat cable.

According to the above aspect, the ink detection unit can be disposed at a desired position not only at the end portion of the multi-core flat cable.

(5) In the liquid leakage detection device according to the aspect, a first electrode terminal that is one of the pair of electrode terminals and is configured with an exposed portion of the first core is electrically coupled to the detection circuit. A second electrode terminal that is the other of the pair of electrode terminals and is configured with an exposed portion of the second core is grounded. A third electrode terminal that is one of the other pair of electrode terminals and is configured with an exposed portion of the third core is electrically coupled to the detection circuit. A fourth electrode terminal that is the other of the other pair of electrode terminals and is configured with an exposed portion of the fourth core is grounded. The detection circuit may output a signal indicating that a leakage of a liquid is detected when a short circuit between the pair of electrode terminals or a short circuit between the other pair of electrode terminals is detected by detecting a voltage drop in the first core or the third core.

(6) In the liquid leakage detection device according to the aspect, the detection circuit includes a first leakage signal terminal electrically coupled to the first core, a first ground terminal electrically coupled to the second core, a second leakage signal terminal electrically coupled to the third core, a second ground terminal electrically coupled to the fourth core, and a pull-up resistor having one end coupled to a high-potential side of a signal potential used by the detection circuit. The first ground terminal and the second ground terminal may be grounded, and the first leakage signal terminal and the second leakage signal terminal may be coupled to the other end of the pull-up resistor.

(7) In the liquid leakage detection device according to the aspect, the detection circuit may include at least one comparator to detect a voltage drop in the first core or the third core.

(8) In the liquid leakage detection device according to the above aspect, the detection circuit may include at least one analog-to-digital converter to detect a voltage drop in the first core or the third core.

(9) According to another aspect of the present disclosure, there is provided an ink jet recording apparatus. The ink jet recording apparatus includes a liquid flow unit, an ejection execution unit, a case accommodation unit, a control unit, and a liquid leakage detection device. The liquid leakage detection device includes an ink detection unit configured with, as a pair of electrode terminals, an exposed conductor portion of a first core included in a multi-core flat cable and an exposed conductor portion of a second core included in the multi-core flat cable; and a detection circuit configured to detect that a liquid leaks by detecting that a potential difference between the pair of electrode terminals is less than a threshold defined in advance.

According to the above aspect, by using, as the ink detection unit, the exposed portion of the core included in the multi-core flat cable, the space occupied by the ink detection unit in the ink jet recording apparatus can be reduced, and the space efficiency inside the ink jet recording apparatus can be improved.

The present disclosure is not limited to the above-described aspect as an ink jet recording apparatus, and can be realized in various aspects such as an ink jet system, a multifunction peripheral including the ink jet recording apparatus, and the like.

What is claimed is:

1. A liquid leakage detection device provided inside an ink jet recording apparatus, the device comprising:
an ink detection unit configured with, as a pair of electrode terminals, an exposed conductor portion of a first core included in a multi-core flat cable and an exposed conductor portion of a second core included in the multi-core flat cable; and
a detection circuit configured to detect that a liquid leaks by detecting that a potential difference between the pair of electrode terminals is less than a threshold defined in advance.

2. The liquid leakage detection device according to claim 1, further comprising:
a second ink detection unit configured with, as another pair of electrode terminals, an exposed conductor portion of a third core included in the multi-core flat cable and an exposed conductor portion of a fourth core included in the multi-core flat cable, wherein
the detection circuit detects that a liquid leaks by detecting that a potential difference between the pair of electrode terminals or between the other pair of electrode terminals is less than the threshold defined in advance, and
the second ink detection unit is disposed at a position different from a position where the ink detection unit is disposed.

3. The liquid leakage detection device according to claim 2, wherein
the first core and the second core are disposed adjacent to each other in the multi-core flat cable, and the third core and the fourth core are disposed adjacent to each other in the multi-core flat cable,
the second core is adjacent to the third core on a side opposite to the first core,
the pair of electrode terminals are configured with a conductor portion of the first core exposed on one surface of the multi-core flat cable and a conductor portion of the second core exposed on the surface,
the other pair of electrode terminals are configured with a conductor portion of the third core exposed on the surface and a conductor portion of the fourth core exposed on the surface,
the first core and the second core extend in a direction different from a direction in which the third core and the fourth core extend by at least the first core and the second core being disposed while being bent in a state where a split is formed from an end of the multi-core flat cable along a spacing between the second core and the third core, and
the pair of electrode terminals and the other pair of electrode terminals are disposed along the same plane inside the ink jet recording apparatus.

4. The liquid leakage detection device according to claim 2, wherein
the first core and the second core are disposed adjacent to each other in the multi-core flat cable, and the third core and the fourth core are disposed adjacent to each other in the multi-core flat cable,
the second core is adjacent to the third core on a side opposite to the first core,
the pair of electrode terminals are provided in a vicinity of one end portion of the multi-core flat cable, and
the other pair of electrode terminals are provided in an intermediate region of the multi-core flat cable.

5. The liquid leakage detection device according to claim 3, wherein
a first electrode terminal that is one of the pair of electrode terminals and is configured with an exposed portion of the first core is electrically coupled to the detection circuit,
a second electrode terminal that is the other of the pair of electrode terminals and is configured with an exposed portion of the second core is grounded,
a third electrode terminal that is one of the other pair of electrode terminals and is configured with an exposed portion of the third core is electrically coupled to the detection circuit,
a fourth electrode terminal that is the other of the other pair of electrode terminals and is configured with an exposed portion of the fourth core is grounded, and
the detection circuit
outputs a signal indicating that a leakage of a liquid is detected when a short circuit between the pair of electrode terminals or a short circuit between the other pair of electrode terminals is detected by detecting a voltage drop in the first core or the third core.

6. The liquid leakage detection device according to claim 5, wherein
the detection circuit includes
a first leakage signal terminal electrically coupled to the first core,
a first ground terminal electrically coupled to the second core,
a second leakage signal terminal electrically coupled to the third core,
a second ground terminal electrically coupled to the fourth core, and
a pull-up resistor having one end coupled to a high-potential side of a signal potential used by the detection circuit,
the first ground terminal and the second ground terminal are grounded, and
the first leakage signal terminal and the second leakage signal terminal are coupled to the other end of the pull-up resistor.

7. The liquid leakage detection device according to claim 6, wherein
the detection circuit includes at least one comparator to detect a voltage drop in the first core or the third core.

8. The liquid leakage detection device according to claim 6, wherein
the detection circuit includes at least one analog-to-digital converter to detect a voltage drop in the first core or the third core.

9. An ink jet recording apparatus comprising:
a liquid flow unit; an ejection execution unit; a case accommodation unit; a control unit; and a liquid leakage detection device, wherein
the liquid leakage detection device includes
an ink detection unit configured with, as a pair of electrode terminals, an exposed conductor portion of a first core included in a multi-core flat cable and an exposed conductor portion of a second core included in the multi-core flat cable, and
a detection circuit configured to detect that a liquid leaks by detecting that a potential difference between the pair of electrode terminals is less than a threshold defined in advance.
